(19) United States
(12) Patent Application Publication
(10) Pub. No.: US 2005/0028366 A1
(43) Pub. Date: Feb. 10, 2005

(54) Method for producing a branch pipe

(76) Inventors: Wilfried Bien, Seevetal-Emmelndorf (DE); Pierre Bonny, Hamburg (DE); Michael Halves, Hamburg (DE); Thomas Huelsberg, Buchholz (DE); Uwe Kluessmann, Bispingen (DE); Holger Nuhn, Schneverdingen (DE); Ralf Puenjer, Seevetal (DE); Olav Reinhardt, Hamburg (DE); Dirk Riewert, Hamburg (DE); Thorsten Sternal, Moisburg (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/491,663

(22) PCT Filed: Sep. 17, 2002
(86) PCT No.: PCT/EP02/10409

(30) Foreign Application Priority Data
Oct. 6, 2001 (DE) 101 49 381.9

(51) Int. Cl. F16L 39/00; F16L 41/00

(52) U.S. Cl. 29/890.148; 29/890.14; 29/890.141; 285/133.6; 285/133.11

(57) ABSTRACT

The invention relates to a method for producing a branch pipe. In order for the dependable production of a branch pipe with virtually any desired design of the branch to be made possible in a simple way it is proposed that an elongate, straight main curvature and at least two lateral curvatures, respectively branching off from a longitudinal side of the main curvature, lying opposite each other with respect to the central longitudinal axis of the main curvature extending in the material of the blank and having a mirror-symmetrically arranged base line are formed from a blank by deep-drawing. After the forming operations, the blank is trimmed in such a way that a vessel-like shell part, which is open in the longitudinal direction, is formed from the main curvature, and half-sleeves, which adjoin the shell part, lie in the same plane as the shell part and are open in the direction of their extent, are formed from the lateral curvatures, and that sheet metal strips serving as joining flanges extend along the outside of the lateral edges of the shell part and the half-sleeves. Subsequently, the shell part is bent about a spatial axis parallel to the central longitudinal axis until the joining flanges corresponding to one another on both sides of the shell part lie against one another, and, after that, the joining flanges are connected to one another.

The invention relates to a method for producing a branch pipe according to the precharacterizing clause of patent claim 1.

Branch pipes are generally produced from deep-drawn half-shells that are welded to each other, in one piece as a casting or by means of internal high-pressure forming from a straight or bent pipe. The first type of production requires a greater amount of handling to join the two half-shells together. Furthermore, two dies are required, making the production tolerances of the individual parts for the joining operation correspondingly high, which makes this operation more difficult. The cast configuration is admittedly much easier with respect to handling, but on the one hand a cast branch pipe is relatively heavy and on the other hand the freedom of design for the branch of the pipe to be produced is considerably restricted with respect to the wall thickness, since very thin walls cannot be dependably formed by the casting technique. Although the internal high-pressure forming technique provides more possibilities in this respect, it also has its limits, in particular as far as the length of the branch is concerned. Furthermore, owing to the material-thinning effects specific to the method, it is only possible with great difficulty and effort—if at all—to form dependable branches from thin-walled pipes.

A method of the generic type is known from EP 0 780 173 A2. In this case, to produce a manifold pipe branch of a motor vehicle exhaust system, a pipe part in the form of a sheet-metal coil or blank is deep-drawn and trimmed in a progressive composite die, thereby forming a semifinished pipe part which corresponds to the rolled-out form of the pipe part in its finished form. The semifinished pipe part is then pre-bent and rolled. The ready-bent rolled part is welded in a gastight manner in its bent-together central contact area.

Furthermore, U.S. Pat. No. 2,262,627 discloses the production of an exhaust manifold of a motor vehicle exhaust system, two deep-drawn half-shells provided with branches being placed one on top of the other and connected to one another by spot welding at the flanges, which protrude from the edge of the shells, to form an exhaust manifold.

The invention is based on the object of presenting a method by means of which the dependable production of a branch pipe with virtually any desired design of the branch is made possible in a simple way.

This object is achieved according to the invention by the features of patent claim 1.

On account of the one-piece form of the branch pipe, handling for production is made easier. The overall production process, comprising pressing, cutting, bending and joining, can be readily automated. Production tolerances are virtually insignificant for dependable production. The fact that the forming of the sleeve takes place by means of deep-drawing means that the freedom of design for the sleeve is virtually unlimited in terms of shape and length. Furthermore, the wall thickness of the pipe can also be greatly reduced without adversely affecting dependability. This is on the one hand favorable for a lightweight construction and on the other hand, when the branch pipe is used in the exhaust line of a motor vehicle, advantageous for fastest possible lighting off of the catalyst, since the thin wall has only a low thermal capacity and consequently extracts relatively little heat from the exhaust flow. The freedom of design makes it possible to form highly curved branches, which, when they are used for the assembly of an exhaust manifold, allows it to be better adapted to the installation space of the engine compartment. Added to this is the fact that the length of the branches can be dimensioned such that no connecting pipe is required any longer to the inlet flange at the cylinder head. Furthermore, the joint seam is positioned in such a way that it is not exposed directly to the flow of the hot exhaust, which is accompanied by a considerable increase in the durability of the exhaust manifold. On account of the position of the joint seam, the seam can be interrupted, at least where it is used in the exhaust line, since a completely gastight seal is not provided in any case on account of the further exhaust pipes that are connected with a sliding fit with play, which minimizes the times involved in production process and consequently makes production less costly.

(There follows the description of the drawings of the exemplary embodiment of the invention, as from page 2, paragraph 2 of the original German documents)

On account of the one-piece form of the branch pipe, handling for production is made easier. The overall production process, comprising pressing, cutting, bending and joining, can be readily automated. Production tolerances are virtually insignificant for dependable production. The fact that the forming of the sleeve takes place by means of deep-drawing means that the freedom of design for the sleeve is virtually unlimited in terms of shape and length. Furthermore, the wall thickness of the pipe can also be greatly reduced without adversely affecting dependability. This is on the one hand favorable for a lightweight construction and on the other hand, when the branch pipe is used in the exhaust line of a motor vehicle, advantageous for fastest possible lighting off of the catalyst, since the thin wall has only a low thermal capacity and consequently extracts relatively little heat from the exhaust flow. The freedom of design makes it possible to form highly curved branches, which, when they are used for the assembly of an exhaust manifold, allows it to be better adapted to the installation space of the engine compartment. Added to this is the fact that the length of the branches can be dimensioned such that no connecting pipe is required any longer to the inlet flange at the cylinder head. Furthermore, the joint seam is positioned in such a way that it is not exposed directly to the flow of the hot exhaust, which is accompanied by a considerable increase in the durability of the exhaust manifold. On account of the position of the joint seam, the seam can be interrupted, at least where it is used in the exhaust line, since a completely gastight seal is not provided in any case on account of the further exhaust pipes that are connected with a sliding fit with play, which minimizes the times involved in the production process and consequently makes production less costly.

Expedient refinements of the invention can be taken from subclaims; otherwise, the invention is explained in more detail below on the basis of an exemplary embodiment represented in the drawings, in which:

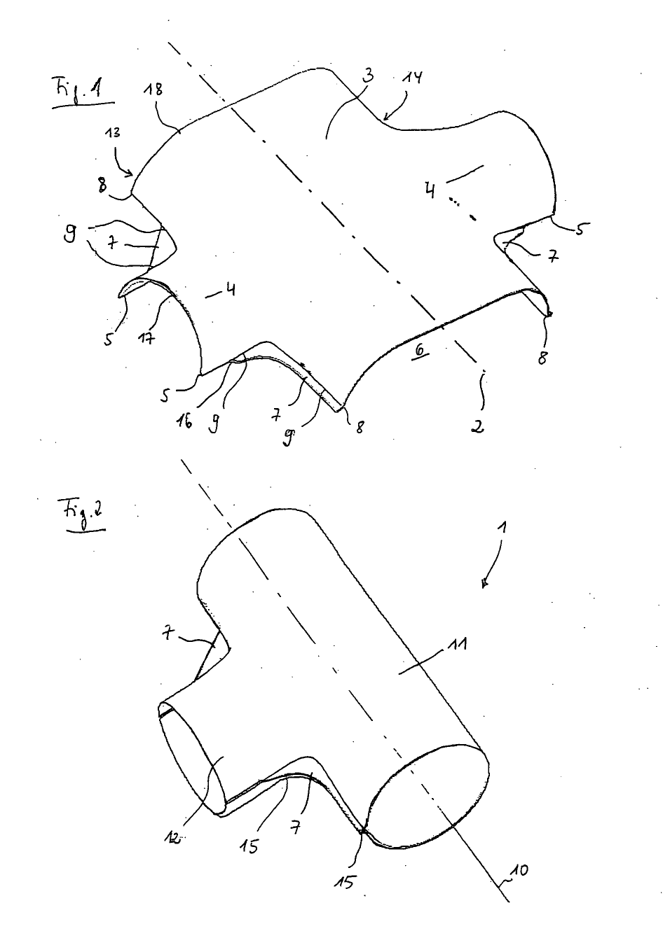

FIG. 1 shows in a perspective plan view a blank which has been deep-drawn and trimmed by the method according to the invention,

FIG. 2 shows in a perspective plan view a branch pipe which has been bent and joined by the method according to the invention from the blank of FIG. 1.

In FIG. 1, an intermediate stage of a method for producing a branch pipe 1 is represented. Firstly used for this purpose is a blank or a section of metal sheet from a coil which has been subjected to a deep-drawing operation. The deep-drawing has the effect of forming from the blank an elongate, straight main curvature and two lateral curvatures, respectively branching off from a longitudinal side of the main curvature and lying opposite each other with respect to the central longitudinal axis 2 of the main curvature extending in the material of the blank. The lateral curvatures are arranged mirror-symmetrically in relation to each other with regard to the shape of their base line. The base line in this case designates the profile of the edge of the opening of the lateral curvatures. Although in the exemplary embodiment shown the lateral curvatures are entirely identical in terms of shape and dimensioning—apart from their mirror-symmetrical arrangement—, the lateral curvatures may also be of different depths, depending on the requirements for the branch to be produced.

After the forming operations on the blank, the latter is trimmed in a way which is economical in terms of the method in the deep-drawing die by means of a punching tool or outside the deep-drawing die in a clamping device by means of a cutting laser which can be three-dimensionally guided. One of the effects of the trimming is to produce a vessel-like shell part 3, which is created from the main curvature and is open in the longitudinal direction. The shell part 3 is rectangular in plan view. However, it may also be shaped as an isosceles trapezoid, for example in one or both directions of the longitudinal extent of the shell part 3. The shell part 3 is adjoined by half-sleeves 4, which lie in the same plane and result from the lateral curvatures. The half-sleeves 4 are open in the direction of their extent and are respectively formed as half circular-cylinders. However, the geometry of the straight, parallel lower edges 5 of the half-sleeves 4 may also be entirely different. For example, they may be formed in such a way that they converge in relation to each other in a curved or straight line. In the latter case, the half-sleeves 4 have the shape of a half-cone. The half-sleeves 4 open as it were into the cavity 6 of the shell part 3 formed by the curvature. Furthermore, sheet metal strips 7 are formed on the shell part 3 and the half-sleeves 4 and, lying in the same plane as the lower edges 5 of the half-sleeves 4 and the lower edges 8 of the shell part 3, extend along the outside of the lateral edges 9 of the shell part 3 and the half-sleeves 4. The sheet metal strips 7 of the shell part 3 and of the half-sleeves 4 are interconnected in one piece, but may also be separate from one another. It is also not absolutely necessary for the entire surface area of the sheet metal strips 7 to be in the same plane as the lower edges 5 of the half-sleeves 4 and the lower edges 8 of the shell part 3. To accomplish later joining operations, the sheet metal strip 7 must in any event extend out of this plane, any deviations from the aforementioned formation requiring at the same time that the sheet metal strips 7 lying opposite one another with respect to the central longitudinal axis 2 are formed with a reverse shape in relation to one another. This is advantageous to the extent that, during the subsequent bending operation, the sheet metal strips 7 engage positively in one another, which consequently ensures better retention for the joining operation and better durability of the joining seam. The sheet metal strips 7 thereby serve as joining flanges.

Subsequently, in a separate tool, the shell part 3 is bent by means of a bending mandrel about a spatial axis 10 parallel to the central longitudinal axis 2, an axis which lies in a plane penetrating through the shell part 3 along the central longitudinal axis 2 in a perpendicular direction and at a distance from the central longitudinal axis 2 (FIG. 2). In the exemplary embodiment shown, the axis 10 lies offset downward from the central longitudinal axis 2 by the radius of the circular-cylindrical main pipe 11 formed by the bending. The bending takes place until the joining flanges 7 corresponding to one another on both sides 13, 14 of the shell part 3 lie against one another with their full surface area. In this case, the lower edges 8 of the shell part 3 on the one hand and the lower edges 5 of the half-sleeves 4 on the other hand respectively come to lie on one another, whereby said main pipe 11 is formed from the shell part 3 and the branch sleeve 12 is formed from the half-sleeves 4, and these in turn together form the branch pipe 1.

Finally, in a final production step, the joining flanges 7 are connected to one another. This may take place by welding, the position of the joining seam 15 and the flatness of the flanges 7 allowing spot welding to be used in a quick, simple and low-cost way. The forming of flanges 7 makes mechanical joining, such as for example clinch-joining, possible for the first time, which considerably enhances the durability of the joining seam 15 and is of advantage in the case of heat-sensitive materials. Furthermore, the use of an adhesive bonding technique is conceivable in the case of applications where there is no or low thermal stress, such as for example in the sanitary sector.

In the present example, the sheet metal strips 7 are formed in such a way that the end 16 of the sheet metal strip 7 running along the half-sleeve 4 is drawn back with respect to the edge 17 of the opening of the half-sleeve 4. The same also applies to one end 18 of the shell part 3. In this way it is ensured that there is nothing impeding the branch pipe 1 when it is connected to further pipes or connections by simple plug-in connections. For example, the branch sleeve 12 can be fitted together in the exhaust line with the inlet flange of the cylinder head in a simple way and, if required, be welded to the flange, while the main pipe 11 can be connected to a further pipe of an exhaust manifold with a sliding fit. To form an exhaust manifold insulated with an air gap, the branch pipe 1 may be connected as an inner part by a plug-in connection to the corresponding sleeves of the outer shell and welded.

Moreover, the solution according to the invention is not restricted to the formation of a single branch sleeve 12. In the case of longer shell parts 3, it is quite possible to use the deep-drawing process to form a number of lateral curvatures or half-sleeves 4, which then form branch sleeves 12 once the production method has been completed. Depending on the requirements for the spatial and/or flow conditions, these may be formed identically to one another or differently with respect to shape and length.

1-3. (canceled)

4. A method for producing a branch pipe adapted to be located in the exhaust line of a motor vehicle, comprising:
forming an elongate, straight main curvature and at least two lateral curvatures, branching off from the longitudinal sides of the main curvature, lying opposite each other with respect to the central longitudinal axis of the main curvature extending in the material of a blank, and having a mirror-symmetrically arranged base line, from a blank by deep drawing,
trimming the blank in such a way that a vessel-like shell part, which is open in the longitudinal direction, is formed from the main curvature, half-sleeves, which adjoin the shell part, lie in the same plane as the shell part and are open in the direction of their extent, are formed from the lateral curvatures, and sheet metal strips serving as joining flanges extend along the outside of the lateral edges of the shell part and the half-sleeves,
subsequently bending the shell part about a spatial axis parallel to the central longitudinal axis until the joining flanges corresponding to one another on both sides of the shell part lie against one another, and
connecting the joining flanges to one another by clinch-joining.

5. The method as claimed in claim 4, wherein an end of the sheet metal strip running along the half-sleeve is drawn back with respect to an edge of the opening of the half-sleeve.

6. A branch pipe produced by the method of claim 4.

7. A branch pipe provided by the method of claim 5.
